(19) United States
(12) Patent Application Publication
(10) Pub. No.: US 2011/0154365 A1
(43) Pub. Date: Jun. 23, 2011

(54) METHOD FOR DETECTING AND CONTROLLING CONTENTION OF CONVERGENCE SERVICE BASED ON RESOURCE

(75) Inventors: Jaecheol SIM, Daejeon (KR); Kee Seong Cho, Daejeon (KR)

(73) Assignee: Electronics and Telecommunications Research Institute, Daejeon (KR)

(21) Appl. No.: 12/969,938

(22) Filed: Dec. 16, 2010

(30) Foreign Application Priority Data
Dec. 18, 2009 (KR) 10-2009-0127207

(51) Int. Cl. G06F 9/46

(52) U.S. Cl. 719/313

(57) ABSTRACT

Provided is a method for detecting and controlling a contention of a convergence service based on resources. The method may analyze a contention between a plurality of applications through modeling of the resources, messages, and applications, establish a resolution policy, and detect and control the contention between the plurality of applications using the established resolution policy.

### CROSS-REFERENCE TO RELATED APPLICATION

This application claims the benefit of Korean Patent Application No. 10-2009-0127207, filed on Dec. 18, 2009, in the Korean Intellectual Property Office, the disclosure of which is incorporated herein by reference.

### BACKGROUND

1. Field of the Invention

Embodiments of the present invention relate to a method for sensing and controlling a convergence service contention based on resources, and more particularly, to a method for sensing and controlling a contention occurring between a plurality of applications.

2. Description of the Related Art

Generally, services providing a basic connection over a communication network are provided together with supplementary services. In this instance, since a number of the supplementary services increases and various schemes for providing the supplementary services exist, services existing in the communication network may need to be constantly controlled in response to demands of users. That is, it is very important that the services are provided without a contention occurring between the services existing in the communication network.

In particular, in an Internet Protocol (IP) network environment, various supplementary services passively using a profile, a presence, multi-media, and the like may be provided. In this instance, a newly advanced service obtained by combining the supplementary services, that is, a convergence service may be provided.

When the convergence service is provided, it is important to quickly deploy a new service to create the convergence service. To quickly deploy the new service, a technology that may be used, as a web interface, an application program interface (API) required for controlling a service by abstracting a function of a communication network may be used. For example, Parlay X may be used.

Also, when a plurality of supplementary services exists in the communication network, services pursuing mutually different goals between the plurality of services or competing for the same network resource may exist. In this case, a contention between the plurality of services may occur, which is referred to as feature interaction.

Also, to control an interaction of the convergence service, an interaction manager scheme may be used. The interaction manager scheme may monitor various events such as a message, and the like occurring in the communication network, and distribute the events to an appropriate application, thereby controlling a convergence service.

A system for providing the convergence service may configure a state transition model of an entire state of a system based on transmission and reception of a message for each service. In this instance, at least two state transitions may occur due to a message triggering different services in a single state. Specifically, a contention between at least two different services may occur.

Accordingly, there is a desire for a method that may detect a contention occurring when the new service is developed and deployed, and may prevent the contention from occurring or may control the contention.

### SUMMARY

An aspect of the present invention provides a method for detecting and controlling a contention of a convergence service based on a resource, which may readily add a new application using a bottom up scheme based on the resource.

Another aspect of the present invention provides a method for detecting and controlling a contention of a convergence service based on a resource, which may sense a contention generated due to a user's contradictory intention that is difficult to be detected, by performing a contention detecting and control based on the resource.

According to an aspect of the present invention, there is provided a method for detecting and controlling convergence service contention, the method including: analyzing a contention between a plurality of messages based on a modeled resource and message; analyzing a contention between a plurality of applications based on the analyzed contention between the plurality of messages; establishing a resolution policy for controlling an actual contention between the plurality of applications based on the analyzed contention between the plurality of application; and detecting the actual contention between the plurality of applications by managing a state of each resource at a point in time when executing a application, and performing a contention control in accordance with the resolution policy.

The analyzing of the contention between the plurality of messages may predict the contention between two messages when the two messages may change the state of one resource to each different state or request the same mutually exclusive resource or write

to the same database (DB) resource or the same address resource.

The analyzing of the contention between the plurality of applications predict the contention between two applications when the contention is predicted between one of the messages used by the single application and one of the messages used by another application.

The establishing of the resolution policy may establish the resolution policy with respect to a pair of messages generating each contention between the plurality of applications when the contention predicted between the plurality of applications is analyzed.

The detecting the actual contention may include: monitoring all messages transmitted/received between the plurality of applications and a network; determining the occurrence of the contention between the plurality of applications using the existence of the resolution policy with respect to each monitored message; and controlling the contention between the plurality of applications triggered due to the message, using the resolution policy when the contention is determined.

The determining the occurrence of the contention using the resolution policy may include: determining whether the resolution policy, where a contention processing scheme of the plurality of applications is defined; and determining whether the resolution policy for a pair of message with respect to the monitored message is defined for the plurality of applications; and determining the occurrence of the contention when an instance of the same resource is used by the pair of messages.

### Effect

According to embodiments of the present invention, it is possible to easily add a new application with simple contention detection and control scheme using a bottom up analysis based on a resource.

Also, according to embodiments of the present invention, it is possible to detect a contention generated due to a user's contradictory intention that is difficult to be sensed, by performing a contention detecting and control based on the resource since the user's contradictory intention is expressed as contradictory usage for the resource.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an operation environment of a system for detecting and controlling a contention of a convergence service;

FIG. 2 is a flowchart illustrating a method of analyzing a contention of a convergence service;

FIG. 3 is a flowchart illustrating a method of controlling a contention between applications using a resolution policy when the contention between the applications occurs;

FIG. 4 is a flowchart illustrating message sequence for a charged video on demand service (VoD);

FIG. 5 is a flowchart illustrating message sequence for a discount on advertisement VoD service; and

FIG. 6 is a diagram illustrating correlation between a resource corresponding to an application providing a charged (VoD) service and an advertisement VoD service.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

In general, in a communication network, a specific system may receive and analyze messages transmitted between network elements, and infer a state of a network resource through the message analysis.

Also, a request from each of application servers where an application is executed may be converted to a appropriate message between network elements to be transmitted. Through the transmission of the message, the network resource requested by the service may be controlled.

In this instance, the message analysis and a message distribution may be performed by a service broker. Specifically, the service broker may be a system that may receive and analyze the messages between the base network and the application servers, and distribute the messages to an appropriate application server and network element.

For example, when an interface provided by the service is a web service type, a web service gateway may be the service broker. Also, when both the base network and the application are using the web service interface, a service bus may be the service broker.

Hereinafter, embodiments of the present invention will be described in detail with reference to appended drawings. For convenience of description, a communication network may be referred to as a base network, and a convergence service control system using an interface in a web service type will be described as an example.

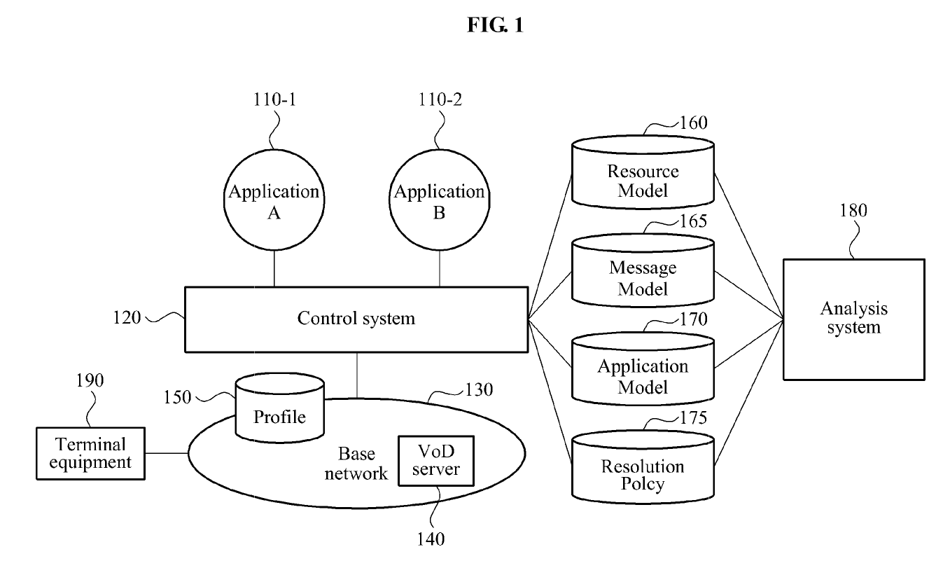

FIG. 1 is a diagram illustrating an operation environment of a system for detecting and controlling a contention of a convergence service.

Referring to FIG. 1, the system for detecting and controlling the contention of the convergence service includes a plurality of applications 110-1 and 110-2, a control system 120, a base station 130, a video on demand (VoD) server 140, a profile DB 150, a plurality of data bases (DBs) 160, 165, 170, and 175, an analysis system 180, and a terminal equipment 190. In this instance, for convenience of description, an example where the plurality of applications 110-1 and 110-2 is executed by different application servers will be described.

The control system 120 may set a connection with the base network 130. Also, the control system 120 may relay a connection between the base network 130 and the plurality of application servers.

Also, each of the plurality of application servers may use various communication services provided through the base network 130. In this instance, each of the plurality of application services may use services provided through the base network 130 by calling an Application Program Interface (API) provided in the control system 120.

The base network 130 may include the VoD server 140 and a plurality of servers providing resources used for providing services. Also, the base network 130 may include the profile DB 150 where service information for each user is stored.

In this instance, the control system 120 may use information of the profile DB 150 existing the base network 130 so that applications corresponding to the plurality of application servers are performed through the plurality of application servers.

The analysis system 180 may establish a resolution policy by analyzing contention information. Next, the control system 120 may control various contentions occurring when providing the convergence service, based on the established resolution policy.

In this instance, in the plurality of DBs 160, 165, 170, and 175, information required for performing a contention analysis and a contention control in the control system 120 and the analysis system 180 may be stored. Accordingly, the information stored in the plurality of DBs 160, 165, 170, and 175 may be shared by the control system 120 and the analysis system 180. Here, the plurality of DBs 16, 170, and 175 may be respectively implemented as an independent application. Also, the plurality of DBs 160 165, 170, and 175 may be positioned within the control system 120 or the analysis system 180 to provide information to another system.

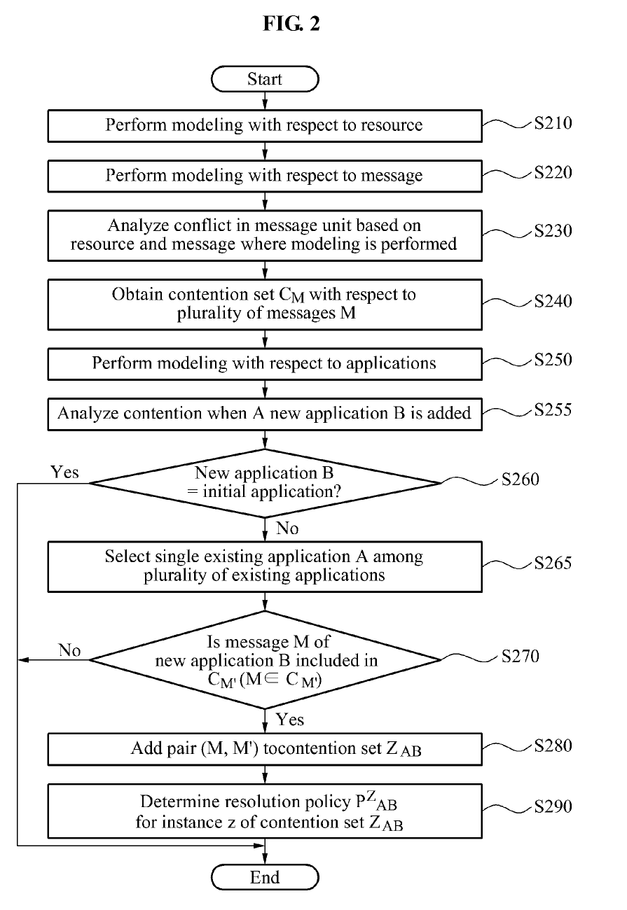

FIG. 2 is a flowchart illustrating a method of analyzing a contention of a convergence service.

Referring to FIG. 2, in operation S210, the analysis system 180 may model a plurality of resources. Next, the modeled resources may be stored in a resource model DB 160.

More specifically, the analysis system 180 may identify resources required for providing services requested by the terminal equipment 190, from among the plurality of resources.

The analysis system 180 may model resources by determining a state and attributes of each of the identified resources, and store the modeled resources in the resource model DB 160. Here, the modeled resources may include a server resource, a transmission resource, an address resource, an application resource, and a DB resource.

For example, the server resource may include a processor, the transmission resource may include a bandwidth, and the address resource may include a calling party number, a called party number, or an identifier of contents. Also, the application resource may include a display of a terminal, and the DB resource may include a field of a specific data stored in a DB.

Also, an attribute of each of the resources modeled in the analysis system 180 may include a minimum or maximum value for the number of the resource, and a type of the resource. Also, the attribute of the resource may include information regarding whether a mutual exclusion with respect to a time and a space occurs.

In operation S220, the analysis system 180 may model a plurality of messages. Accordingly, the modeled message may be stored in the message model DB 165. Here, the plurality of messages may include messages defined by the plurality of applications as well as the message provided by the control system 120.

More specifically, the analysis system 180 may identify a resource required for performing a function or a service corresponding to the message and a resource affected due to the execution of the service. Also, the analysis system 180 may determine states before and after processing the message, and model the message. For example, the analysis system 180 may model the resource and the message using an extensible markup language (XML).

In operation S230, the analysis system 180 may analyze a contention between a plurality of messages, based on the modeled resource and message. For example, the analysis system 180 may analyze a contention predicted between a plurality of messages using a graph search scheme.

More specifically, when a state of the same resource is changed to different sates by two different messages or two identical messages, the analysis system 180 may predict a contention between the two messages.

Also, when a single resource where a mutual exclusion condition is set by the two messages is requested, the analysis system 180 may predict the contention between the two messages.

Also, when at least two write accesses to the same DB resource or the same address resource are generated by the two messages, the analysis system 180 may predict the contention between the two messages. In this instance, for convenience of description, the contention predicted with respect to two messages has been described, however, the analysis system 180 may predict a contention predicted with respect to every pair of messages.

In operation S240, the analysis system 180 may obtain a contention set, which is a set of messages that a contention is predicted for a message. For example, the analysis system 180 may obtain a contention set C_{M} which is a set of messages that a contention is predicted with respect to a message M.

In operation S250, the analysis system 180 may model a plurality of applications. Accordingly, the modeled applications may be stored in the application model DB 170. In this instance, the modeled application may include a sequence of a message to be transmitted and received by an application server where an application is executed.

When the plurality of applications is modeled, the analysis system 180 may analyze a contention between the applications based on the contention set for each message. In this instance, the analysis system 180 may predict the contention between the applications when a new application is added to a system, or when a user activates a new application with subscription. That is, in operation S255, the analysis system 180 may analyze the contention when a new application is added to the system. In operation S260, the analysis system 180 may determine whether a new application B is the first application to the system. In this instance, when the new application B is the first application (YES branch), the analysis system 180 may terminate the contention analysis for the new application B.

In operation S265, when the new application B is not the first application (NO branch), the analysis system 180 may select a single arbitrary application A among a plurality of existing applications. Here, at least one of the existing application may exist.

In operation S270, the analysis system 180 may determine whether a message M called by the new application B is included in a contention set C_{M′} of a message M′ called by the selected existing application A. This step is performed for every pair of message called by application A and message called by application B.

In operation S280, when the message M called by the new application B is included in a contention set C_{M′} (YES branch of operation S270), that is, MεC_{M′}, the analysis system 180 may add, to a contention set Z_{AB}, a pair of messages z=(M, M′) including the message M of the new application B and the message M′ of the existing application A. Here, the contention set Z_{AB} may be a set of messages where a contention is predicted between the application A and the application B.

In operation S290, the analysis system 180 may establish a resolution policy (P^{Z}_{AB}) for each pair of messages z belong to the contention set Z_{AB}.

In this instance, the analysis system 180 may store the established resolution policy in the resolution policy DB 175. Specifically, in the resolution policy DB 175, the resolution policy for processing a contention between the new application B and the existing application A may be stored. Here, in the resolution policy, a processing method of a case where an actual contention occurs with respect to the pair z of the messages included in the contention set Z_{AB} may be defined.

For example, the resolution policy may designate performing or suspending a message in accordance with a priority of messages where a contention occurs. Also, the resolution policy may designate prompting user to decide the priority.

Also, in the same manner as that of the above, the analysis system 180 may analyze a contention with respect to all messages M called by the new application B and all messages M′ called by the existing application A.

Next, the analysis system 180 may repeat a sequence of processing of selecting another existing application to establishing resolution policy for the contention between the newly selected existing application and new application B 5265 to 5290, until every existing application are selected for processing.

In this manner, the analysis system 180 may predict a potential contention between the applications or the messages through the contention analysis between the new application B and the existing application A. However, the predicted contention may not be generated at a point in time when an application is performed.

For example, when two different applications display each image and a screen can display only one image, a possibility where a contention occurs between the two applications may be high. However, when a screen used by a plurality of applications is provided in different terminal equipments, or when the plurality of applications is sequentially occupy the screen, a contention between the plurality of applications may not occur. In this case, a corresponding analysis may be possible only when an actual application is executed.

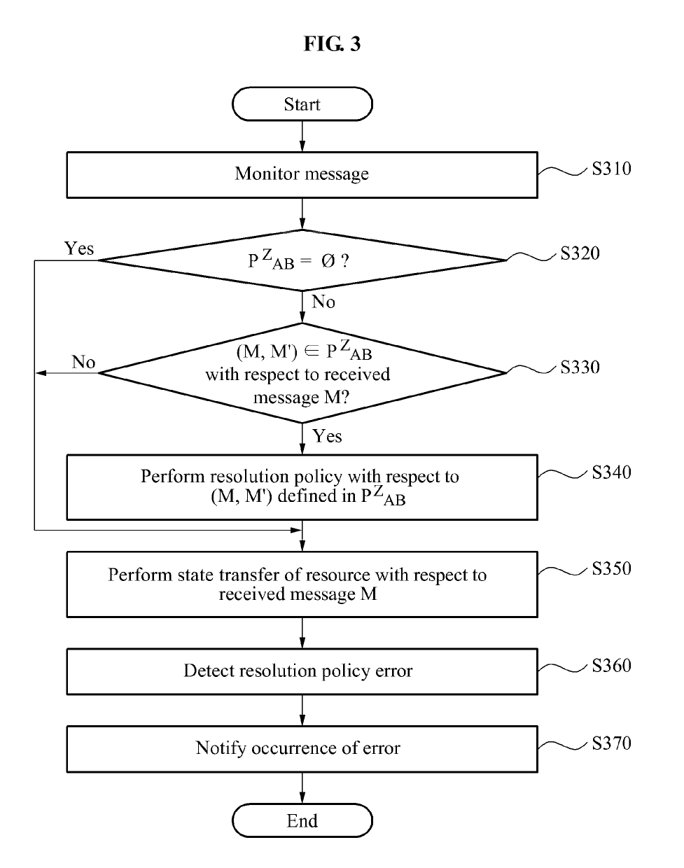

FIG. 3 is a flowchart illustrating a method of controlling a contention between applications using a resolution policy when the contention between the applications occurs. In FIG. 3, the application B has been already registered and the resolution policy for the contention between the other existing application A.

Referring to FIG. 3, in operation S310, the control system 120 may monitor all messages transmitted and received between an application server where each of applications is performed and the base network 130.

In operation S320, the control system 120 may determine whether the resolution policy (P^{Z}_{AB}) stored in the resolution policy DB 175 is a null set to determine whether a plan for processing a contention is defined.

In operation S330, when the resolution policy (P^{Z}_{AB}) is not the null set (S320:NO), the control system 120 may determine whether the pair z of messages exists with respect to the monitored message M. Specifically, the control system 120 may analyze whether the pair z=(M, M′) of the messages is included in the resolution policy (zεP^{Z}_{AB}).

More specifically, when the pair of the messages (z=(M, M′)) is included in the resolution policy (YES branch of operation S330), the control system 120 may determine that an occurrence of a contention between the applications A and B is predicted by the message M.

In operation S340, the control system 120 may control the contention based on the resolution policy. Specifically, the control system 120 may perform the resolution policy with respect to the pair of the messages (z=(M, M′)) based on the resolution policy DB 175 when and the message M and the message M′ share the same instance of resources.

For example, the control system 120 may perform or suspend a message in accordance with priority of the messages M and M′ corresponding to the applications B and A where the occurrence of the contention is predicted, based on the resolution policy DB 175. Accordingly, the control system 120 may predict and prevent the contention between the applications B and A in prior to the occurrence of the contention.

In operation S350, the control system 120 may perform a state transition of a resource with respect to the received message M. In this instance, the control system 120 may perform the state transition of the resource corresponding to each of the modeled messages, based on the message model DB 165.

When the resolution policy (P^{Z}_{AB}) is the null set (YES branch of operation S320) or when the pair of the messages (z=(M, M′)) is included in the resolution policy (NO branch of operation S330), the control system 120 may perform the state transition of the resource with respect to the received message M.

In operation S360, the control system 120 may verify whether an error exists in the resolution policy.

More specifically, the control system 120 may verify whether the error exists in the resolution policy based on the state transition of the resource used by the received message M.

For example, when the resource, which is mutual exclusive, is in the occupied state and the message M try to change the state of the resource to the occupied state again, the control system 120 may determine that the error exists in the resolution policy.

In operation S370, the control system 120 may inform the analysis system 180 that the error exists in the resolution policy. For example, the control system 120 may transmit an error message to the analysis system 180, and thereby inform the system operator that the error exists in the resolution policy. Accordingly, the system operator may modify the resolution policy P^{Z}_{AB} based on the received error message, and store the supplemented resolution policy P^{Z}_{AB} in the resolution policy DB 175.

In this instance, when the error does not exist in the resolution policy, the control system 120 may repeatedly monitor the message between application servers 110 and the base network 130. Accordingly, the control system 120 may detect and control a contention occurring between the application B and the application A.

The control system 120 may predict the contention between the applications based on the resource, and control the predicted contention as indicated in FIG. 3.

More specifically, the control system 120 may predict the contention between the applications using a bottom up scheme in the following sequential order of the resource, the message, and the application, and control the predicted contention.

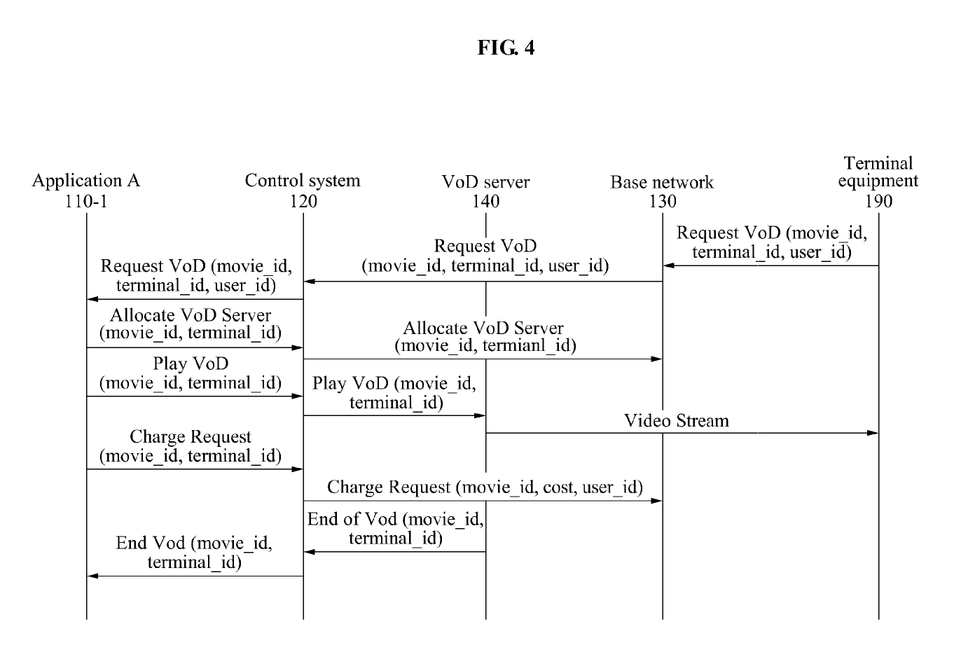

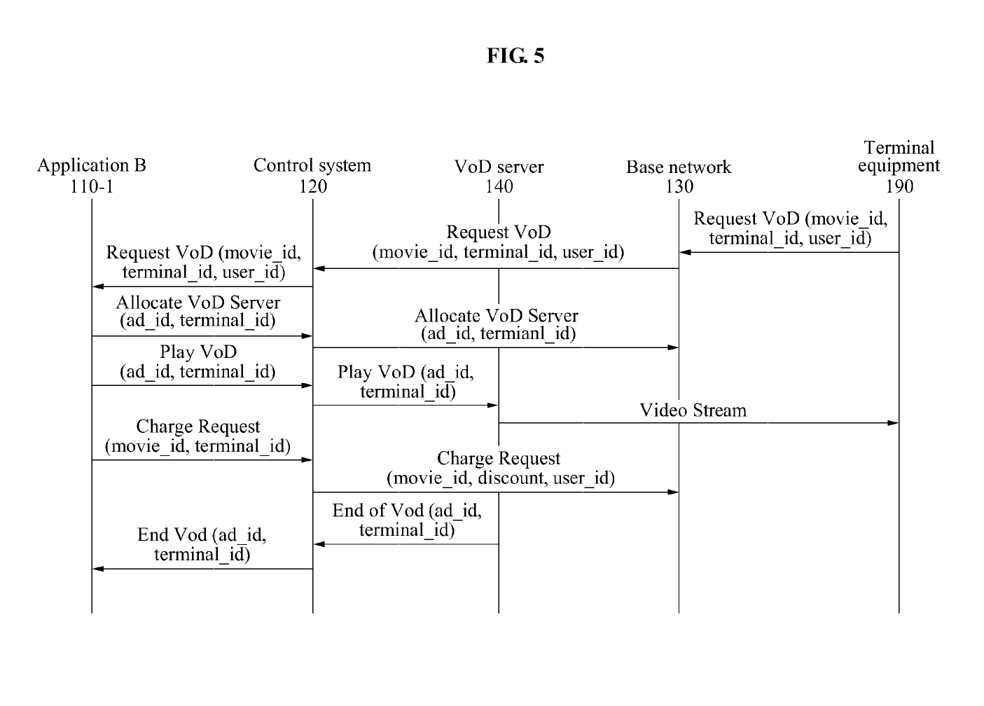

Hereinafter, in a case where specific applications are used, the method for sensing and controlling the contention of the convergence service will be described with reference to FIGS. 4 and 5.

FIG. 4 is a flowchart illustrating message sequence for a charged video on demand service (VoD), and FIG. 5 is a flowchart illustrating message sequence for a discount on advertisement VoD service.

In FIGS. 4 and 5, it is assumed that a VoD service is provided through an Internet Protocol television (IPTV) service network. Referring to FIG. 4, an application server A where the application A for providing the charged VoD service may receive a message requesting the VoD service from the terminal equipment 190. In this instance, the message requesting the charged VoD service may be transmitted to the application server A through the control system 120. Next, the application server A may set a connection between the VoD server 140 and the terminal equipment 190. Also, the application server A may request VoD server to transmit video stream corresponding to the requested VoD to the terminal equipment 190, and may charge a fee based on charge information stored in the profile DB 150.

Referring to FIG. 5, an application server B where an application B for providing a discount on advertisement VoD service may receive a message requesting the VoD service from the terminal equipment 190 as same as application server A.

But, the application server B may set a connection between the VoD server 140 and the terminal equipment 190 to deliver advertisement before transmitting video stream corresponding to the requested VoD.

Also, the application server B may charge a fee such that a discounted fee based on the charge information stored in the profile DB 150.

In this instance, a contention between the existing application A and the new application B provided as indicated in FIGS. 4 and 5 may occur from two aspects.

For example, with respect to a single message of “request VoD”, the existing application A may set a connection with the VoD server providing the requested movie, and the new application B may set a connection with the VoD server providing the advertisement before the requested movie. Accordingly, a contention between the existing application A and the new application B may occur.

Also, the existing application A charges a usage fee for the requested movie. In a case of the new application B charges a discounted fee for the same requested movie. Accordingly, the contention between the existing application A and the new application B may occur.

In this instance, to provide the charged VoD and the discount on advertisement VoD through the existing application A and the new application B, the VoD server, the address resource, and the DB resource may be used as indicated in FIGS. 4 and 5. Here, the VoD server may provide the requested movie or the advertisement to the terminal equipment. Also, the address resource may include a user identifier, a terminal identifier, a VoD identifier, and an advertisement VoD identifier. The DB resource may be used for recording charging information of the user.

For example, resources provided over the base network may be expressed as below.

```
  <Resources>
  <Resource Name=“VoD Server” Type=“Server”>
    <Cardinality Min=“0” Max=“Infinite”/>
    <States Type=“Cardinality”/>
<MutualExclusive>False</MutualExclusive>
</Resource>
  <Resource Name=“ChargingValue” Type=“DB”>
    <Cardinality Min=“1” Max=“1”/>
    <States Type=“Enumeration”>
      <State>Idle</State>
<State>Locked</State>
    </States>
    <MutualExclusive>True</MutualExclusive>
  </Resource>
<Resource Name=“Display” Type=“Display”>
    <Cardinality Min=“0” Max=“1”/>
<States Type=“Enumeration”>
      <State>Idle</State>
<State>Busy</State>
    </States>
    <MutualExclusive>True</MutualExclusive>
  </Resource>
  <Resource Name=“Connection” Type=“Aggregate”>
      <Resource Name=“OriginatingAddress” Type=“Id”>
<Cardinality Min=“1” Max=“1”/>
<States Type=“Cardinality”/>
        <MutualExclusive>True</MutualExclusive>
      </Resource>
<Resource Name=“TerminatinggAddress” Type=“Id”>
<Cardinality Min=“1” Max=“1”/>
<States Type=“Cardinality”/>
        <MutualExclusive>True</MutualExclusive>
      </Resource>
<Resource Name=“Bandwidth” Type=“Bandwidth”>
<Cardinality Min=“0” Max=“Infinite”/>
<States Type=“Cardinality”/>
        <MutualExclusive>False</MutualExclusive>
      </Resource>
  </Resource>
</Resources>
```

Here, an allocate VoD server, a play VoD, and a charge request messages may be used for allocating or changing the resources.

Also, a display allocated by a play VoD message may be canceled using an end VoD message. Also, a connection between the terminal equipment and the VoD server may be canceled by the end VoD message.

Also, a fee of a user corresponding to the requested VoD may be added or reduced by the charge request message. In this instance, since the addition or reduction of the fee of the user is performed by correcting values stored in the profile DB 150, a contention may occur when a mutual exclusive condition for the profile DB 150 is not satisfied.

Accordingly, by analyzing, in a message unit, the contention between the existing application A and the new application B, the analysis system 180 may predict that a contention would occur due to two allocate VoD server messages, two play VoD messages, a play VoD and VoD message, two end VoD messages, or two charge request messages.

In this instance, a contention set C_{M} obtained from the analysis system 180 may be expressed as below.

<ContentionSet>
<Contention Message=“Allocate VoD Server”>
<Message>Allocate VoD Server</Message>
</Contention>
<Contention Message=“Charge Request”>
<Message>Charge Request</Message>
</Contention>
<Contention Message=“Play VoD”>
<Message>Play VoD</Message>
<Message>End VoD</Message>
</Contention>
</ContentionSet>

Also, the existing application A and the new application B may be expressed as below. Here, since the existing application A and the new application B have different message parameters, however, follow the same message sequence, the existing application A and the new application B may be expressed in the same manner. Also, to express a execution sequence of various applications, the application model may be expressed through a condition, a parallel execution, a loop, and the like, including a sequential sequence described in the following embodiment

```
<Application>
<ExecutionPath>
<Sequential Execution>
      <Receive>Request VoD</Receive>
      <Send>Allocate VoD Server</Send>
      <Send>Play VoD</Send>
      <Send>Charge Request</Send>
      <Receive>End VoD</Receive>
</Sequential Execution>
<ExecutionPath>
</Application>
```

Here, when the application A is added in a system, since an application does not exist on the system, a contention with other applications may not occur. In this instance, when the new application B is added in the system, the analysis system 180 may calculate a contention set Z_{AB} to sense a contention possibility between the new application B and the existing application A.

For example, Z_{AB} may include {(Charge Request, Charge Request), (Play VoD, Play VoD), (Play VoD, End VoD), (End VoD, End VoD), (Allocate VoD Server, Allocate VoD Server)}. Next, the analysis system may establish a resolution policy for each of pairs of messages based on Z_{AB}. The established resolution policy may be stored in the resolution policy DB 175.

For example, the analysis system 180 may establish the resolution policy such that the existing application A is performed in advance with respect to a pair of messages of (Charge Request, Charge Request), the new application B is performed in advance with respect to a pair of messages of (Play VoD, Play VoD), and the new application B is performed with respect to a pair of messages of (Play VoD, End VoD) and then the existing application A is performed, and may store the established resolution policy in the resolution policy DB 175.

In this instance, since the advertisement is transmitted in advance, a contention may not occur by an end message such as a message of (End VoD, End VoD). Also, in a case of a message of (Allocate VoD Server, Allocate VoD Server), since different contents are allocated, the analysis system 180 may remove a message of (Allocate VoD Server, Allocate VoD Server) from a contention set.

As described above, in a case where the charged VoD service and the discount on advertisement VoD service are provided, the method for detection and controlling the contention has been described with reference to FIGS. 4 and 5.

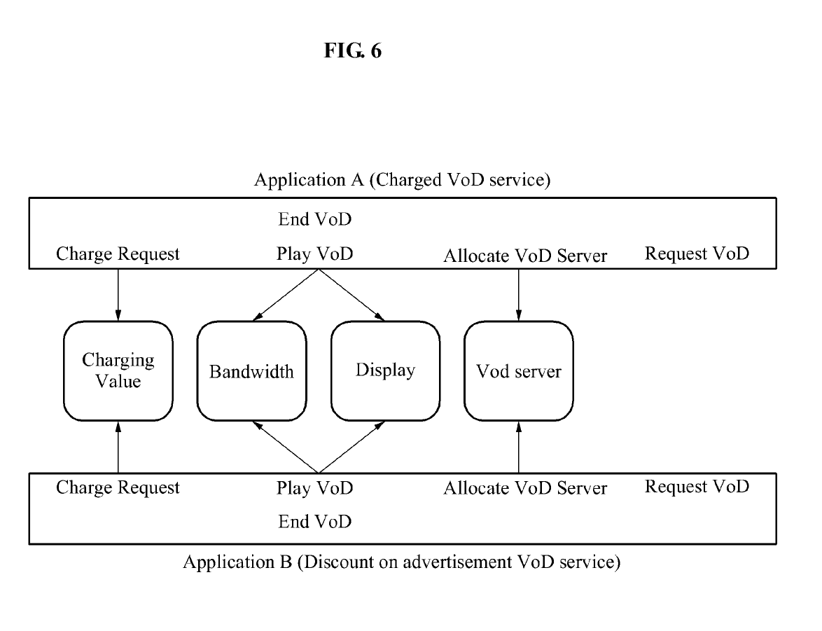

FIG. 6 is a diagram illustrating correlation between a resource corresponding to an application providing the charged video on demand (VoD) service and the discount on advertisement VoD service.

Referring to FIG. 6, when a service is provided by a request of the terminal equipment 190, the control system 120 may receive a request VoD message from the base network, and transmit the received message to an application server. Next, the analysis system 180 may determine that the resolution policy P^{Z}_{AB} is not a null set, and the existing application A and the new application B is in service. In this instance, the control system 120 may retrieve the resolution policy, and control the contention between the existing application A and the new application B.

More specifically, in FIG. 6, when an allocate VoD server message is transmitted by the existing application server A or the new application server B, the allocate VoD server message does not belong to the contention set, and the control system 120 may change a state of a corresponding VoD server resource. Through the transition of the state, the control system 120 may verify that the corresponding VoD server resource is allocated.

Also, when the play VoD message is transmitted, the control system 120 may retrieve the resolution policy, and recognize that a play VoD message of the new application B needs to be processed in advance.

In this instance, when the existing application A requests the play VoD message to be processed in advance, the control system 120 may delay the processing of the request of the existing application A until a processing for the play VoD message corresponding to the new application B is completed based on the established resolution policy.

When the resolution policy is not properly established with respect to a pair of messages of (Play VoD, End VoD), the play VoD message may be transmitted from the existing application server A before an advertisement is terminated by the end VoD message transmitted from the new application server B. In this instance, a state where a display resource required for processing the play VoD message is occupied by the new application server B. Here, as for the display resource, a mutual exclusion condition may be set.

Accordingly, the state transfer for the resource may not be performed by the play VoD message transmitted from the existing application server A. In this manner, when the state transition for the resource is impossible, the control system 120 may detect that an error exists in the resolution policy.

Accordingly, the control system 120 may transmit, to the analysis system 180, a message informing about an occurrence of the error in the resolution policy. Next, the analysis system 180 may identify the corresponding error in the resolution policy based on the received error message, and modify the resolution policy.

For convenience of description, a case where two applications are used has been described, however, this is merely an example. Thus, even in a case where at least three applications are used, the method for sensing and controlling the contention of the convergence service may be applied.

Also, each of a plurality of applications is performed through a plurality of different application servers, however, this is merely an example. Thus, the plurality of applications may be performed in a single application server.

Also, as described above, for convenience of description, the system for controlling the convergence service using an interface of a web service type has been described, however, basic operations for controlling the convergence service may be the same even in a service bus, a service broker, a web service gateway, and the like. Accordingly, the system for controlling the convergence service according to an embodiment is not limited to the web service gateway.

Also, the resource provided by the base network may be identified, and abstracted. Accordingly, to control the resource provided by the base network and monitor a change in the state, the application may be loaded in a communication system as a web service interface type.

More specifically, when the VoD service is provided in the communication network, each of functions used to provide moving pictures may be provided as a control API for moving picture resources. For example, as examples of the functions to provide the moving pictures, a connection setting for the moving pictures, a connection cancellation for the moving picture, a replay for the moving picture, a pause for the moving picture, a stop for the moving picture, and the like may be given. Next, the application server may call APIs through the web service interface, and perform a control for the VoD service. In this instance, an API controlling each resource through Parlay X and the state of the resource may be defined, and an API for receiving information about a change in the state of the resource may be also defined. Accordingly, the application server may provide a service implemented by itself to enable the service to be used in other application servers.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for detecting and controlling convergence service contention, the method comprising:
analyzing a contention predicted between a plurality of messages based on a modeled resource and message;
analyzing a contention predicted between a plurality of applications based on the analyzed contention predicted between the plurality of messages;
establishing a resolution policy for controlling an actual contention between the plurality of applications based on the analyzed contention predetermined between the plurality of application; and
detecting the contention predicted between the plurality of applications by managing a state of each resource at a point in time when performing a service based on the established resolution policy, and performing a contention control in accordance with the resolution policy.

2. The method of claim 1, wherein the analyzing of the contention predicted between the plurality of messages analyzes the contention to be predicted between the plurality of messages when the plurality of messages change the state of a resource to each different state.

3. The method of claim 1, wherein the analyzing of the contention predicted between the plurality of messages analyzes the contention to be predicted between the plurality of messages when the plurality of messages request the same mutually exclusive resource.

4. The method of claim 1, wherein the analyzing of the contention predicted between the plurality of messages analyzes the contention to be predicted between the plurality of messages when the plurality of messages write to the same database (DB) resource or the same address resource.

5. The method of claim 1, wherein the analyzing of the contention predicted between the plurality of applications predict the contention between the plurality of applications when the contention between one of the messages used by a single application and one of the messages used by another applications.

6. The method of claim 1, wherein the establishing of the resolution policy establishes the resolution policy with respect to a pair of messages generating each contention between the plurality of applications when the contention predicted between the plurality of applications is analyzed.

7. The method of claim 1, wherein the detecting of the actual contention comprises: monitoring all messages transmitted/received between the plurality of applications and a base network;
determining the occurrence of the contention predicted between the plurality of applications using the existence of the resolution policy with respect to each monitored message; and
controlling the contention between the plurality of applications triggered due to the message, using the resolution policy when the contention is determined.

8. The method of claim 7, wherein the determining the occurrence of the contention using the resolution policy comprises:
determining whether the resolution policy for the plurality of applications is defined; and
determining whether the resolution policy for a pair of message with respect to the monitored message is defined for the plurality of applications; and
determining the occurrence of the contention when an instance of the same resource is used by the pair of messages.
